(19) United States
(12) Patent Application Publication
(10) Pub. No.: US 2011/0162420 A1
(43) Pub. Date: Jul. 7, 2011

(54) ELECTRONIC LOCKING DEVICE HAVING VARIABLE SECURITY CODE NUMBER INPUT UNIT

(75) Inventor: Sang Ok Lee, Bucheon-City (KR)

(73) Assignee: MILRE SYSTEK CO., LTD, Bucheon-City (KR)

(21) Appl. No.: 12/997,827

(22) PCT Filed: Aug. 27, 2009
(86) PCT No.: PCT/KR09/04784

§ 371 Date: Dec. 13, 2010

(30) Foreign Application Priority Data
Sep. 2, 2008 (KR) 10-2008-0086196
Jan. 5, 2009 (KR) 10-2009-0000496

(51) Int. Cl. E05B 17/10

(52) U.S. Cl. 70/330

(57) ABSTRACT

Provided is an electronic locking device having a variable security code number input unit. The security code number input unit includes two or more input sets, each of which input elements indicated by numbers, letters, or a combination thereof, and preferably some or all of the numbers from 1 to 9 or from 0 to 9, are fixedly arranged. When an input signal is applied, a microcontroller enables light sources for the input elements of all or some of the input sets to emit light such that a real input set is made up of numbers, letters, or a combination thereof, and preferably of a combination of some or all of the numbers from 1 to 9 or from 0 to 9. Thereby, it is possible to prevent the possibility of revealing the security code number, to minimize power consumption, and to ensure that the security code number is easy to input.

### TECHNICAL FIELD

The present invention relates, in general, to an electronic locking device having a variable security code number input unit and, more particularly, to an electronic locking device, capable of preventing a security code number from being exposed, minimizing power consumption, and ensuring handy input of the security code number, in which:

a security code number input unit is employed which includes two or more input sets, each of which inputs elements indicated by numbers, letters, or a combination thereof, and preferably some or all of the numbers from 1 to 9 or from 0 to 9, are fixedly arranged, unlike conventional technologies associated with a touch screen having an input unit in which positions for displaying the numbers are made random in order to prevent a security code number from being exposed by fingerprints;

the security code number input unit differently allocates the numbers indicated by adjacent input elements of the different input sets; and

when an input signal is applied, a microcontroller enables light sources for the input elements of all or some of the input sets to emit light such that a real input set made up of numbers, letters, or a combination thereof, and preferably a combination of some or all of the numbers from 1 to 9 or from 0 to 9 is selected.

### BACKGROUND ART

A keypad having a touch screen structure endows water proofing and damp proofing abilities and maintains a high gloss state on the whole without buttons being externally exposed, which is disclosed in Korean Utility Model Registration No. 20-0433819 (published on Dec. 20, 2006) entitled “keypad having water and moisture proof structure for digital door locks”.

As shown in FIG. 1, the keypad includes a touch sensor module 21, which recognizes different capacitance values according to a response position when a touch panel 22 is indirectly touched and compares the recognized value with a previously input reference value, and thereby opens or closes a digital door lock 10 along with producing a sound. The touch sensor module 21 is inserted into a casing 20, one side of which is open. The touch panel 22 of the touch sensor module 21 is air-tightly fixed to the open side of the casing 20, and the key pad having the touch sensor module 21 housed in the casing 20 is installed on the keypad section of the digital door lock 10.

Such a keypad applied to the keypad section of the digital door lock is not a keypad, which has a mechanical operation structure vulnerable to water proofing and damp proofing, but an air-tight keypad in which the touch sensor module is housed, so that it is possible to thoroughly interrupt water or moisture coming in from the outside.

However, the door lock employing this touch screen technique uses a dark colored touch screen such that the touch sensor modules and light emitting diodes (LEDs) can be hidden. A luster is added to the surface of the touch screen to add beauty to the structure. Thus, when a security code number is input by being touched by a finger, the fingerprints of the finger are left behind. The fingerprints are left untouched because it is inconvenient to remove the fingerprints one by one after the door lock is used. This leads to the problem of providing a basis for an illegal intruder discerning the security code number.

To solve this problem, numeral keys displayed on a touch panel are configured so that an array pattern thereof is randomly changed when a start/stop button is manipulated, which is disclosed in Korean Patent Application Publication No. 2003-0066474 (published on Aug. 9, 2003) entitled “Multi-Functional Door Lock Apparatus.”

Further, technology for randomly varying the array of a keyboard including numerals and special letters in the event of each entry being authenticated and displaying the variable keyboard on a display unit is disclosed in Korean Patent No. 10-0790027 (published on Jan. 2, 2008) entitled “Digital Door lock for Preventing Exposure of Security code numbers and Method of Performing Entry Authentication Using the Same.”

Technology for varying the position of a numeral key using a signal input by a numeral key variation request signal input key provided to a key input section when some numeral keys of the key input section are abnormally operated is disclosed in Korean Patent No. 10-0693331 (published on Mar. 12, 2007) entitled “Digital Door Lock Having Device for Varying Keypad Arrangement and Method of Varying Keypad Arrangement.”

Technology for randomly varying the position of a security code number when the security code number is input to display a display keypad is disclosed in Korean Patent Application Publication No. 2008-0070319 (published on Jul. 30, 2008) entitled “Door Lock Having Touch Screen and Method of Opening/Closing Door Using the Same.”

All of the related arts are based on a method of preventing an illegal intruder from finding the security code numbers from only the fingerprints of the touch screen. To this end, a plurality of touch sensor modules and a plurality of luminous numeral displaying means, each of which has one flexible numeric display (FND) or seven LEDs, are arranged on the touch screen, thereby varying the positions of the numerals each time.

According to this FND-based method, one FND or seven LEDs must be installed on a 1-digit touch recognition module that detects a change in capacitance generated when a finger touches the touch screen and an output signal is generated, so that the cost of production is increased.

Particularly, in comparison with the typical method where only one LED is used to represent one number, the FND or seven LEDs consume several times as much power as does one LED.

As such, the FND-based method fails to meet a minimum power consumption condition indispensable for electronic locking devices (e.g. digital door lock) supplied with power from a battery.

Furthermore, according to the related arts, a shape of the number represented by seven segments is unnatural. Further, since the position of the number represented each time is changed, a user has no alternative but to slowly input the security code number for accurate inputting. As such, it is difficult for the user who is old or young or has a low power of concentration to adapt to the changing number positions.

### DISCLOSURE

### Technical Problem

Accordingly, the present invention has been made keeping in mind the above problems occurring in the related art, i.e. the problems of the conventional touch screen that leaves behind fingerprints, and the problems of the technologies associated with the touch screen having an input unit, in which positions for representing the numbers are randomized, and having difficulty in being applied to an electronic locking device using a battery power supply due to a lot of power being consumed.

The present invention is intended to provide an electronic locking device having a variable security code number input unit, in which:

an security code number input unit is employed which includes two or more input sets, each of which input elements indicated by numbers, letters, or a combination thereof, and preferably some or all of the numbers from 1 to 9 or from 0 to 9, are fixedly arranged, unlike conventional technologies associated with a touch screen having an input unit in which positions for representing the numbers are randomized in order to prevent a security code number from becoming known by the fingerprints, and allocates the numbers indicated by the adjacent input elements of the different input sets differently; and

when an input signal is applied, a microcontroller enables light sources for the input elements of all or some of the input sets to emit light such that a real input set made up of numbers, letters, or a combination thereof, and preferably of a combination of some or all of the numbers from 1 to 9 or from 0 to 9 is selected.

Further, the present invention is intended to provide an electronic locking device, in which one light source (e.g. a Light Emitting Diode (LED)) per input element is provided to minimize power consumption, and a touch screen is installed to provide a security code number input unit that is easily controlled and is compact.

The present invention is also intended to provide an electronic locking device, in which:

when three input elements forming one column or row are selected from a first input set where irradiated numbers are arranged in three columns, three input elements that are made up of the numbers different from those of the column or row selected from the first input set and form one column or row as well is selected from the second input set or the second and third input sets; and

the numbers have regularity so that an old or young user or a user who has a low power of concentration can sufficiently adapt to the changing number position in an easier manner.

In addition, the present invention is intended to provide an electronic locking device, in which a condenser or a light trap is provided to a light source to collect light on each of input elements that belong to different input sets and are arranged at positions adjacent to each other.

### Technical Solution

In an aspect, the present invention provides an electronic locking device having a variable security code number input unit, in which locking-unlocking means is operated when numbers input into the security code number input unit are matched with stored setup values, characterized in that:

the security code number input unit includes two or more input sets, on each of which input elements for displaying numbers, letters, or a combination thereof are fixedly arranged, the input elements being brightly displayed by light sources; and

when an input signal is applied, a microcontroller causes the light sources to emit light for the real input elements of all or part of the input sets such that a real input set having the numbers, the letters, or a combination thereof is selected.

In the electronic locking device, the input elements of the security code number input unit may include all or some of the numbers from 1 to 9 or from 0 to 9.

The real input elements irradiated by the light sources may have a combination of all or some of the numbers from which the real input set are selected, which are those numbers from 1 to 9 or from 0 to 9.

In the electronic locking device, the numbers or letters indicated by the input elements that belong to different input sets and are adjacent to each other may be different from each other.

In the electronic locking device, each input element may include one light source. The security code number input unit may include a touch screen.

Furthermore, in the electronic locking device, the input sets may number two or three. The input elements of the first input set of the input sets may be sequentially arranged so as to be in three columns within a range of from 1 to 9. The second input set, or the second and third input sets may be made up of the input elements having an arrangement where the columns or rows of the input elements of the first input set having continuous numbers are changed in position.

When the input signal is applied, the microcontroller may cause the column or row of the input elements made up of discontinuous numbers to be selected from the first input set, and may cause the column or row of the input elements made up of the numbers different from those of the column or row selected from the first input set to be selected from the second input set or the second and third input sets.

In the electronic locking device, light traps may be installed between the light sources for the adjacent input elements of the input sets different from each other. Apart from or together with the light trap, each light source may include a condenser.

### ADVANTAGEOUS EFFECTS

As described above, the electronic locking device according to the present invention is constructed so that, even when the security code number is repetitively pressed, the position of the security code number pressed on the touch screen changes each time, so that an illegal intruder can never find out the security code number only because of the fingerprints of the touch screen, and thus security can be maintained and safe usage ensured.

In this process, the input sets, each of which input elements indicated by numbers, letters, or a combination thereof, and preferably the numbers from 1 to 9 or from 0 to 9, are fixedly arranged, and are displayed, and thus the positions of the displayed numbers are fixed to some extent.

Thus, positional consistency is secured to some extent. As such, it is possible to increase an input speed of the security code number. The numbers have positional regularity, so that the user who is old or young or has a low power of concentration can sufficiently adapt to the changes in number position, and thus can use the numbers in an easier manner.

Particularly, two light sources (e.g. LEDs) are allocated to each number, so that it is possible to produce effects similar to the related art in which one FND or seven LEDs per number are used to convert and display number position arrangement.

As such, the cost of production is inexpensive, and the consumption of current can be maintained to the same level as an existing button-based electronic locking device. Accordingly, it is possible to fulfill the condition that the power consumption of the electronic locking device must be minimized. In this respect, the electronic locking device of the present invention has excellent originality, as well as technical and commercial utility.

### DESCRIPTION OF DRAWINGS

FIG. 1 is a view for explaining a conventional electronic locking device using a touch recognition module;

FIG. 2 is a block diagram showing an electrical construction of an electronic locking device according to the present invention;

FIG. 3 is a flowchart showing operation of a security code number input unit in the electronic locking device according to the present invention;

FIG. 4 shows the number position arrangement on a touch screen constructing a security code number input unit in the electronic locking device according to the present invention; and

FIGS. 5 through 7 show construction of a touch screen forming a security code number input unit in the electronic locking device according to the present invention.

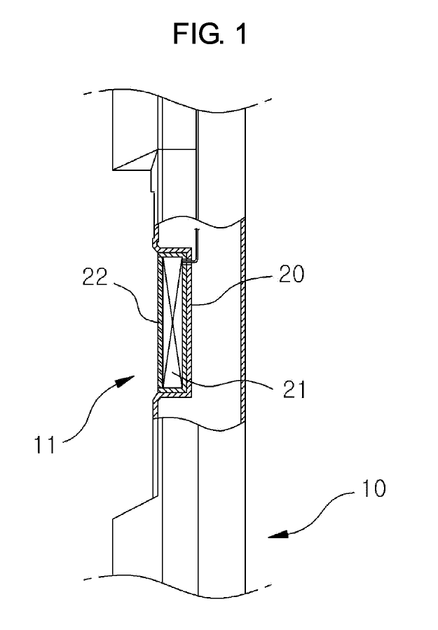

### DESCRIPTION OF SYMBOLS OF THE MAIN PARTS IN THE DRAWINGS

100: microcontroller
101: power supply
102: sensing switch unit
103: driving circuit
104: driving motor
105: data memory
106: display unit
107: touch screen
108: touch recognition module
109: low voltage check unit
110: LED
111: light transmission window
112: light trap
113: condenser

### BEST MODE

Hereinbelow, exemplary embodiments of the present invention will be described in detail with reference to the accompanying drawings.

Herein, in connection with an electronic locking device having a displacement type security code number input unit according to the present invention, an example where a touch screen used for a digital (or electronic) door lock is configured of an input unit will be chiefly described with reference to the accompanying drawings. However, the spirit of the present invention is adapted to be applied to a conventional button-based electronic locking device wherein the numerals displayed are randomized to form a random number pattern, thereby making it possible to contribute to minimizing exposure of a security code number.

Further, the spirit of the present invention can be directly applied to or modified and applied to various locking devices having an electronic security code number input unit for opening various doors having a sliding type or an opening/closing type, drawer-type storage boxes, chests of drawers, ornamental cabinets, wardrobes, safes, and so on, which should also be interpreted as falling within the scope of the present invention.

Further, symbols represented on input elements (projected buttons or flat panel display) constituting a security code number input unit will be described below on the basis of Arabic numbers (0 through 9). The concept of the present invention does not preclude converting Arabic numbers into graphic symbols (e.g., [symbol] , [symbol] , [symbol] , . . . ; one, two, three, . . . ), symbols, numbers, or letters that comply with the usual practices or are promised for individual purposes, or a combination thereof.

In the security code number input unit of the electronic locking device which is a known random number generation type and a touch screen type and has numbers (i.e., input elements), each of which is made up of a flexible numeric display (FND) or seven segment light emitting diodes (LEDs), when a real security code number input unit is displayed each time, real input elements (numbers) undergo a change in position and simultaneously are located at specific positions. Further, the numbers to be indicated by the input elements that are not yet brightly displayed (i.e. that are potential) are also not specified.

In contrast, the security code number input unit of the electronic locking device according to the present invention is a “fixed” type where brightly displayed real input elements are subjected to a change in position but are located at specific positions, and where the numbers or letters to be indicated by the input elements that are not yet brightly displayed (i.e. that are potential) are previously designated. Thus, the input elements constituting each of the input sets of the security code number input unit are “fixedly arranged.”

Further, light sources for brightly displaying the input elements corresponding to the digits required for numbers and symbols (0 through 9, and # and *) will be described as being implemented as LEDs, each of which has the advantages of a small size, light weight, small heat generation, semipermanent duration, high-speed response characteristic, pulse operation characteristic, direct current and alternating current operable characteristic, and optical power controllable characteristic base on current. However, the light source is not limited to the LED.

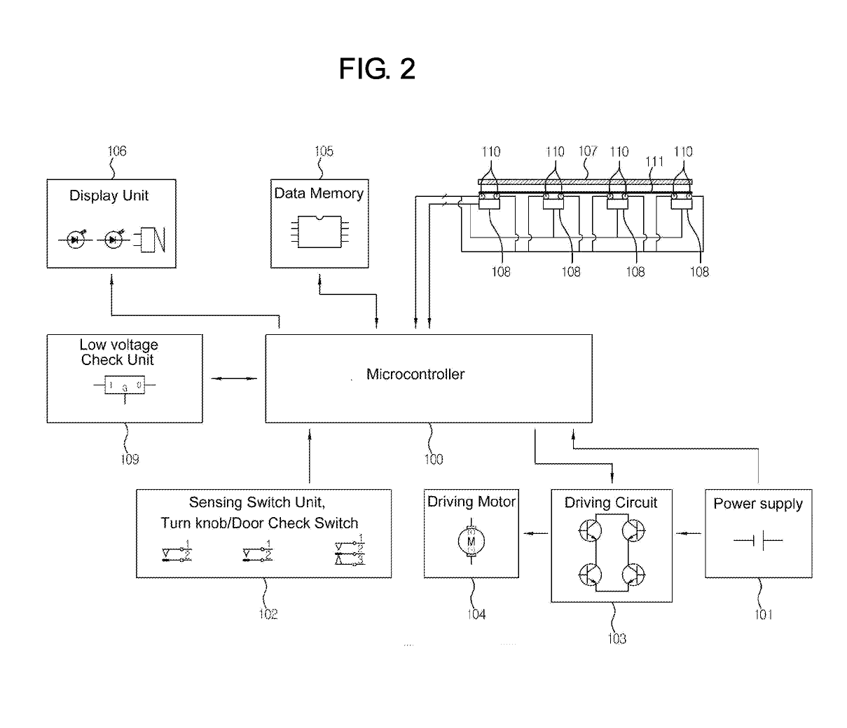

Referring to FIG. 2 that is a block diagram showing the electrical configuration of the electronic locking device according to the present invention, the electronic locking device has a construction similar to that of a known touch screen-type electronic locking device, and may include:

a power supply 101 connected to a microcontroller 100;

a sensing switch unit 102 having a turn knob switch, a door check switch, etc. for sensing a door open state, and an operation state of each component for an opening and closing operation of a door;

a driving circuit 103 and a driving motor 104 for generating power required for the opening and closing operation of the door;

a data memory 105 in which various data required for the operation are stored;

a display unit 106 having LEDs, etc. for displaying the operation state;

a touch recognition module 108 installed under a touch screen 107; and

a low voltage check unit 109 for, when a voltage of the power supply required for the operation is low, sensing the low voltage.

The driving motor may be replaced by known driving means such as solenoid type driving means, actuator type driving means, or the like, all of which may be genetically called locking-unlocking means.

In the drawings, in the security code number input unit for inputting a security code number, to construct input elements corresponding to respective digits for numbers and symbols (0 through 9, and # and *), one light source 110, i.e. one light emitting diode (LED), is provided above each touch recognition module 108 for each input element.

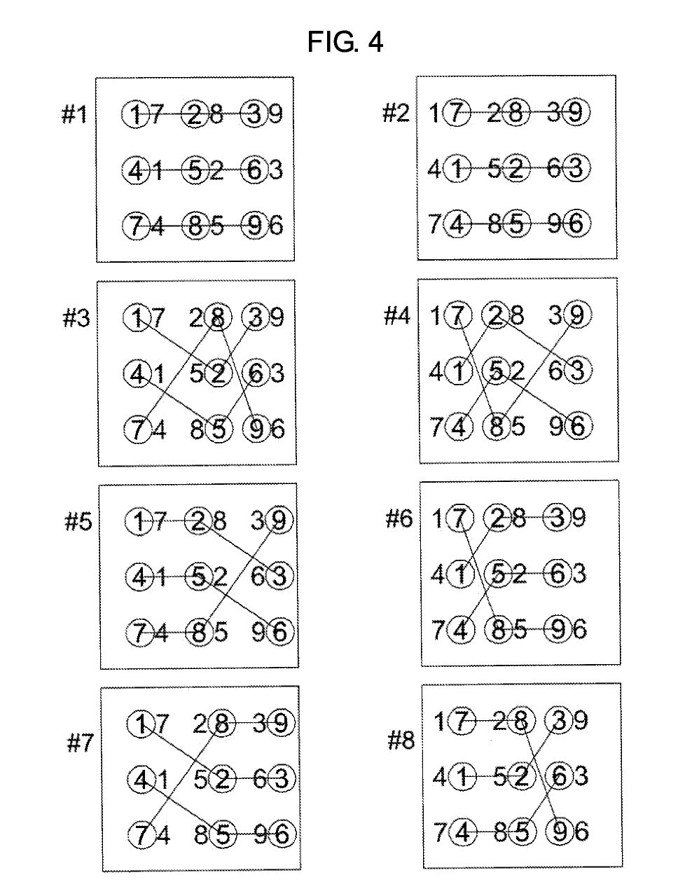

For convenience, it is shown in FIGS. 2 and 4 that the security code number input unit includes two input sets, each of which is made up of nine input elements from 1 to 9 except “0”, “#”, and “*”.

The reason why “0”, “#”, and “*” are not shown in FIG. 4 is as follows. When an input signal is applied, the microcontroller 100 causes the light sources to emit light for the input elements of all or part of the input sets such that a real input set having a combination of numbers from 1 to 9 is arbitrary selected. In contrast, “0”, “#”, and “*” are ready to be used at all times, and thus are merely omitted for convenience. It is apparent that “0”, “#”, and “*” are actually provided to commercial electronic locking devices.

Taking into consideration the fact that the real input set having a combination of numbers from 1 to 9 is selected, it can be said that two LEDs are allocated to each input element corresponding to one number (i.e. one of the numbers from 1 to 9) in the drawings.

In FIG. 2, a light transmission window 111 is installed above the LEDs 110 such that the numbers can be displayed. On expanding the concept of the present invention described in conjunction with FIGS. 2 through 4, nine input elements for the numbers from 1 to 9 are provided for each input set constituting the security code number input unit (wherein “0”, “#”, and “*” required at all times are not arbitrarily selected by the application of the input signal).

If necessary, ten input elements for the numbers from 0 to 9 may be provided (wherein “#” and “*” required at all times are not arbitrarily selected by the application of the input signal).

Further, the input elements for the numbers from 1 to 9 or from 0 to 9 may be provided for each input set in whole or in part. This is because the real input elements, which are selected and brightly displayed by the microcontroller when the input signal is applied and constitute the real input set, have only to form a combination of the numbers of 1 to 9 (where “0”, “#”, and “*” are available at all times) or the numbers of 0 to 9 (where “#” and “*” are available at all times).

The input set from which the real input elements for the real input set are selected by the microcontroller is practically made up of some numbers selected from “all (e.g. two)” of the input sets (e.g. the numbers of 1 to 5 are selected to emit light from the first input set, and the numbers of 6 to 9 are selected to emit light from the second input set). If necessary (when, for example, a person skilled in the art intends to realize a security code number input unit having a different function or to avoid the scope of the present invention), the input set from which the real input elements for the real input set are selected by the microcontroller may be made up of some numbers selected from only “some” of the input sets.

Similarly, if necessary (when, for example, a person skilled in the art intends to realize a security code number input unit having a different function or to avoid the scope of the present invention), the real input elements, which are selected and brightly displayed by the microcontroller and constitute the real input set, may be formed by a combination of “all” or “some” of the numbers from 1 to 9 or the numbers from 0 to 9.

It will be described below with reference to the drawings how the real input elements are selected in part from each of the two input sets having “all” of the numbers of 1 to 9, and thus the real input set having the combination of “all” of the numbers of 1 to 9 is brightly displayed.

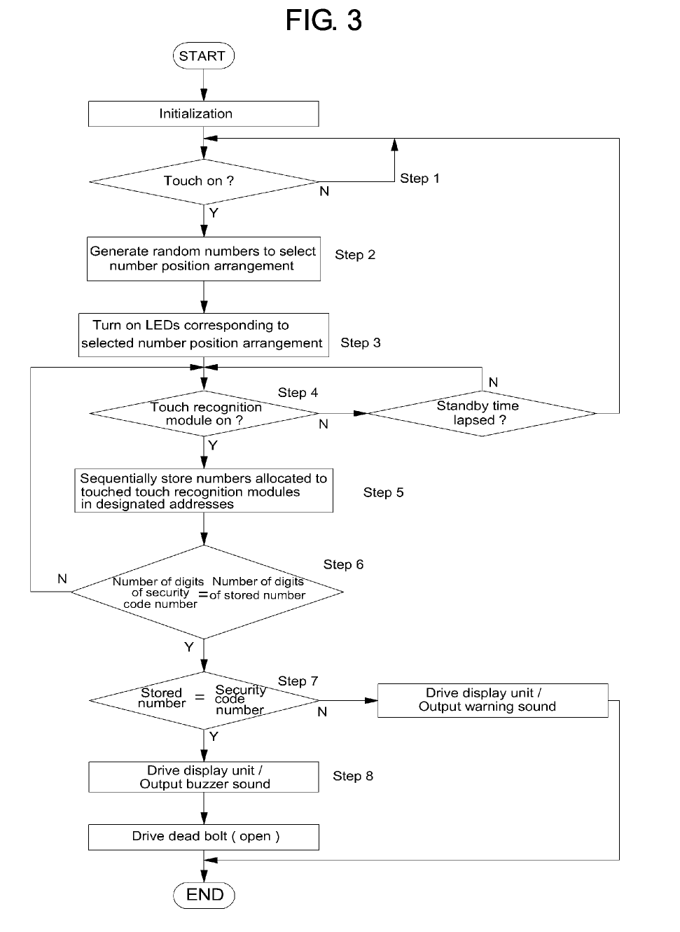

Referring to the flow chart of FIG. 3, the present invention is constructed so that the input elements such as numbers or symbols are on standby without being displayed at normal times when the touch screen 107, which is disposed on the front of the electronic locking device and constructs the security code number unit, is not operated.

In this state, a user touches the touch screen 107 with his/her finger (i.e. an input signal is applied) (in the case of a conventional button-based electronic locking device, an input signal is generated when a user raises and opens a cover covering the security code number input unit).

Then, one or two or more of the touch recognition modules 108 sense the touch, and thus the microcontroller 100 activates the power supply, generates an ON operation signal, and initiates operation (step 1).

In this initial state, the microcontroller 100 generates random numbers first, turns on the LEDs 110 for the input elements at all or part of the input sets made up of the input elements having the numbers from 1 to 9 (or the numbers from 0 to 9), and causes the real input set having a combination of the numbers from 1 to 9 (or the numbers from 0 to 9) to be selected.

In the case of the construction shown in FIGS. 2 and 4, the microcontroller turns on one of two LEDs 110 below two numbers printed on the light transmission window 111 in order to brightly display one number.

If there are two input sets made up of the input elements having the numbers from 1 to 9, all the number position arrangements capable of being obtained by this process are the eight types shown in FIG. 4.

Since one of the eight number position arrangements must be selected, the present invention is constructed to generate random numbers to select one of the eight number position arrangements #1 to #8 (step 2).

If the selected number position arrangement is #7 as one example, the LEDs 110 below the numbers 1, 4 and 7 printed on the light transmission window 111 in the left column of FIG. 4, the LEDs 110 below the numbers 8, 2 and 5 printed on the light transmission window 111 in the middle column of FIG. 4, and the LEDs 110 below the numbers 9, 3 and 6 printed on the light transmission window 111 in the left column of FIG. 4 are turned on (step 3).

Accordingly, the user touches the touch screen 107 with his/her finger while looking at the touch screen 107 on which the numbers of 0 to 9 printed on the light transmission window 111 are brightly displayed. As a result of being touched, each touch recognition module 108 detects a change in capacitance, and thus applies an output signal to the microcontroller 100 (step 4).

The output values of the specific touch recognition modules 108 are converted into the numbers allocated to the respective touch recognition modules 108 by the microcontroller 100, and then are sequentially stored in designated addresses of the data memory 105 (step 5).

Then, it is determined whether or not the number of digits of the stored number is identical to that of the security code number previously input by the user (step 6).

If so, it is determined whether or not the number stored in the data memory 105 is identical to the security code number (step V).

If so, the display unit 106 having, for instance, LED 110 is driven along with a buzzer to inform the user of an open state (step 8).

Subsequently, the driving circuit 103 operates to cause the driving motor 104 to draw a dead bolt into its body, so that the door is opened (step 9). The series of operations is terminated.

Meanwhile, when a preset standby time has lapsed in the state where no touch recognition modules 108 are recognized in step 4, the process returns to its initial state. When the number of digits of the stored number is not identical to that of the security code number in step 6, step 4 of continuously monitoring the touch recognition modules 108 is performed. When the stored number is not identical to the security code number in step 7, the LED 110 of the display unit 106 and the buzzer are operated to indicate that the input is incorrect wherein the buzzer outputs a warning sound. Then, the series of operations is terminated.

Further, when the user touches the touch screen 107 and thus one or more of the touch recognition modules 108 sense the touch (step 1), the process (step 2) of generating random numbers in another number position arrangement is performed.

For example, as in the number position arrangement #4 shown in FIG. 4, the LEDs 110 below the numbers 7, 1 and 4 printed on the light transmission window 111 in the left column, the LEDs 110 below the numbers 2, 5 and 8 printed on the light transmission window 111 in the middle column, and the LEDs 110 below the numbers 9, 3 and 6 printed on the light transmission window 111 in the left column of FIG. 4 are turned on (step 3). In this way, the conversion into the total of eight number position arrangement types can be performed.

The aforementioned concept associated with FIG. 4 is further expanded as follows.

To realize the security code number input unit of the electronic locking device that provides commercial viability and compactness and can be touched with the finger, the number of input sets where the input elements for all or part of the numbers from 1 to 9 or from 0 to 9 are fixedly arranged may be two or three.

Here, the input elements of the first input set of the input sets may be sequentially arranged so as to be in three columns within a range of from 1 to 9.

Here, the term “sequentially” includes the arrangement of the input elements indicated by a solid line in the number position arrangement #1 of FIG. 4 as well as the following arrangement (where the input elements of the first input set are indicated by bold numbers), or the like.

Next, the second input set, or the second and third input sets may be made up of the input elements having the arrangement where the columns or rows of the input elements of the first input set having continuous numbers are changed in position.

In the illustrative arrangement, an example where the arrangement is made only up to the second input set (the input elements of which are indicated by numbers in italics) is shown. Here, the first corresponds to the arrangement where the position of the column varies, and the second corresponds to the arrangement where the position of the row varies.

Further, when the input signal is applied, the microcontroller may cause the column or row of the input elements made up of discontinuous numbers to be selected from the first input set.

Further, the microcontroller may cause the column or row of the input elements made up of the numbers different from those of the column or row selected from the first input set to be selected from the second input set or the second and third input sets, as follows.

In the first arrangement, the columns are selected.

In the second arrangement, the rows are selected.

The input elements that were selected have been underlined.

As described above in conjunction with FIGS. 3 and 4, in the electronic locking device according to the present invention, even when one security code number is stored and pressed by the user, its position can be changed eight times.

As such, the fingerprints are uniformly distributed and left on the surface of the touch screen 107.

In the electronic locking device according to the present invention, since the input position of the security code number continues to be changed, an intruder cannot determine the security code number on the basis of only the fingerprints which result from inputting the security code number.

Moreover, the present invention has an advantage in that, if necessary, the light transmission window 111 is printed such that regions for displaying two or more numbers can be made to transmit light, while the other regions cannot transmit light, and two or more LEDs 110 are installed and controlled by the microcontroller 100, so that it is possible to obtain a combination of still more number arrangements.

Further, the present invention uses the light transmission window 111 printed with desired fonts that are not represented by the FND or seven segment LEDs that cannot diversify the fonts, so that it is possible to display the numbers using the fonts preferred by the user.

Furthermore, as shown in FIG. 4, the present invention allows only one of two columns made up of each of the left-, middle- and right-column numbers to be selectively turned on.

Thus, the numbers displayed by turning on the LEDs 110 are arranged on a straight line in a column so as to have regularity, so that an old or young user or one who has a low power of concentration can sufficiently adapt to the changes in number position, and thus can use the numbers in an easier manner.

Meanwhile, while two LEDs 110 per number are allocated in the present invention, only one LED 110 is turned on at a time in order to display one input element. Thus, the number of LEDs 110 turned on to display the numbers does not change.

As such, the electronic locking device of the present invention can maintain the consumption of current to the same level as an existing button-based electronic locking device, and can meet the condition that the power consumption of the electronic locking device must be minimized.

Further, in the present invention, two LEDs 110 and two numbers per input element for one number are allocated to the light transmission window 111, and the two numbers are prevented from emitting light at the same time.

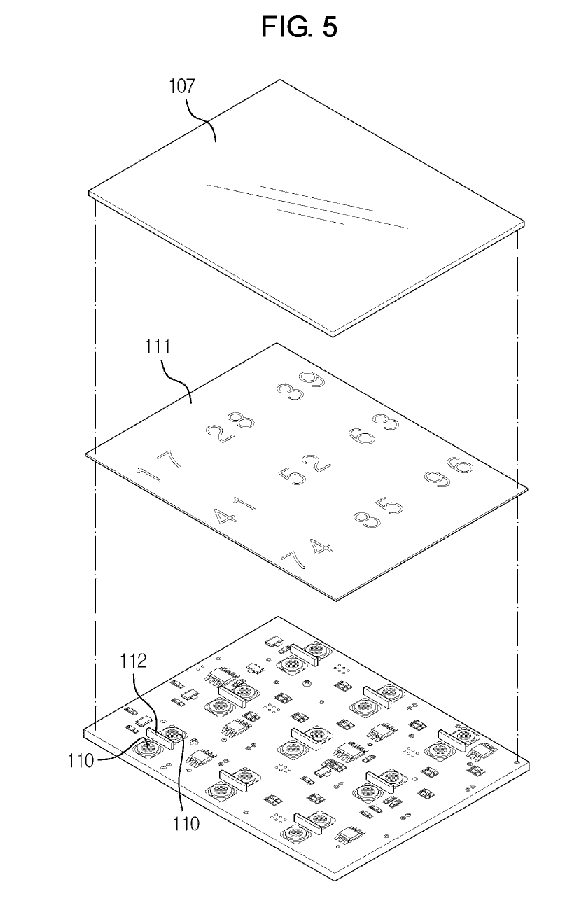

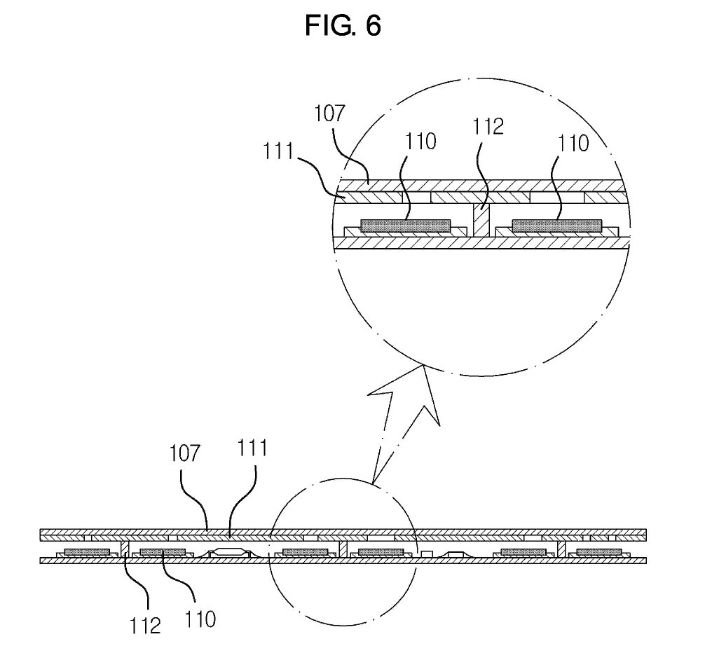

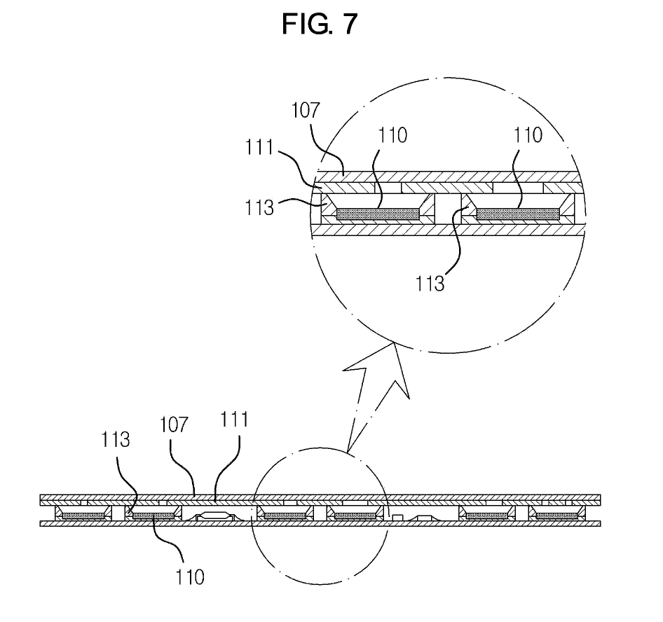

To this end, as shown in FIGS. 5 and 6, a light trap 112 is installed between the two LEDs 110 such that only one of the two numbers can be intensively irradiated. Alternatively (or in combination with the light trap), condensers 113 are installed on the respective LEDs 110 allocated to all the numbers, so that it is possible to further increase luminous intensity.

In the description above, although the generally known technologies associated with the generation of the random numbers are omitted, they can be easily supposed, inferred, and reproduced by those skilled in the art.

Further, although the embodiments of the present invention have been disclosed on the basis of the security code number input unit of a specific structure, those skilled in the art will appreciate that various modifications, additions and substitutions are possible, without departing from the scope and spirit of the invention as disclosed in the accompanying claims.

1. An electronic locking device having a variable security code number input unit, in which locking-unlocking means is operated when numbers input into the security code number input unit are matched with stored setup values, characterized in that:
the security code number input unit includes two or more input sets, on each of which input elements for displaying numbers, letters, or a combination thereof are fixedly arranged;
the input elements are brightly displayed by light sources; and
when an input signal is applied, a microcontroller causes the light sources to emit light for the real input elements of all or part of the input sets such that a real input set having the numbers, the letters, or a combination thereof is selected.

2. The electronic locking device according to claim 1, wherein:
the input elements of the security code number input unit include all or some of the numbers of 1 to 9 or 0 to 9; and
the real input elements irradiated by the light sources are formed of a combination of all or some of the numbers from 1 to 9 or from 0 to 9, which are the numbers from which the real input set is selected.

3. The electronic locking device according to claim 1, wherein the numbers or letters indicated by the input elements that belong to different input sets and are adjacent to each other are different from each other.

4. The electronic locking device according to claim 1, wherein each input element includes one light source.

5. The electronic locking device according to claim 1, wherein the security code number input unit includes a touch screen.

6. The electronic locking device according to claim 1, wherein:
the input sets number two or three;
the input elements of the first input set of the input sets are sequentially arranged so as to be in three columns within a range from 1 to 9; and
the second input set, or the second and third input sets are made up of the input elements having an arrangement where the columns or rows of the input elements of the first input set having continuous numbers are changed in position.

7. The electronic locking device according to claim 6, wherein
when the input signal is applied, the microcontroller causes the column or row of the input elements made up of discontinuous numbers to be selected from the first input set; and
the microcontroller causes the column or row of the input elements made up of the numbers different from those of the column or row selected from the first input set to be selected from the second input set or the second and third input sets.

8. The electronic locking device according to claim 1, further comprising light traps between the light sources for the adjacent input elements of the input sets which are different from each other.

9. The electronic locking device according to claim 1, wherein each light source includes a condenser.
